(19) United States
(12) Patent Application Publication
(10) Pub. No.: US 2021/0281097 A1
(43) Pub. Date: Sep. 9, 2021

(54) Method and device for charging electric energy stores

(71) Applicants: Triathlon Holding GmbH, Pyrbaum OT Seligenporten (DE); Industrie Elektronik Brilon GmbH, Brilon (DE)

(72) Inventors: Stefan FIEDLER, Brilon (DE); Martin HARTMANN, Fürth (DE)

(21) Appl. No.: 17/254,918

(22) PCT Filed: Jul. 10, 2019
(86) PCT No.: PCT/EP2019/068610

§ 371 Date: Dec. 22, 2020

(30) Foreign Application Priority Data
Jul. 12, 2018 (DE) 10 2018 211 633.4

(51) Int. Cl. H02J 7/00; B60L 53/62

(52) U.S. Cl. CPC H02J 7/00714; H02J 7/0013; B60L 2200/42; B60L 53/62; H02J 2310/48; H02J 7/00302

(57) ABSTRACT

A method and a device for charging electric energy stores are described. At least two electric energy stores to be charged are connected to in each case one charger. The electric energy stores are charged with in each case one charging power assigned to the respective charger. The charging powers are subjected to closed-loop control, wherein the instantaneous charging powers of each charger are determined and added to give an instantaneous total charging power. After a comparison of the instantaneous total charging power with a predefined upper charging power limit, at least one of the charging powers assigned to the respective chargers is reduced if the instantaneous total charging power is greater than the upper charging power limit.

### CROSS-REFERENCES TO RELATED APPLICATIONS

This application claims the priority of German Patent Application, Serial No. 10 2018 211 633.4, filed Jul. 12, 2018, the content of which is incorporated herein by reference in its entirety as if fully set forth herein.

### FIELD OF THE INVENTION

The invention relates to a method and a device for charging electric energy stores, in particular for charging batteries for mobile industrial applications, in particular drive batteries for in-plant industrial trucks. The invention relates in particular to a method and a device for charging electric energy stores in the low-voltage range, in particular in the low-voltage range of up to 120 V.

### BACKGROUND OF THE INVENTION

Methods and devices for charging electric energy stores are known. They are used, for example, for charging drive batteries for in-plant industrial trucks. During charging, peak loads can occur. Such peak loads occur in particular at specific times of the day, for example during shift changes, at which a large number of electric energy stores, in particular a large number of drive batteries, are intended to be charged.

### SUMMARY OF THE INVENTION

An object of the present invention consists in specifying an improved method for charging electric energy stores, in particular providing a method with which undesired peak loads can be reduced.

This object is achieved by a method for charging electric energy stores comprising the following steps:
connecting at least two electric energy stores to be charged to in each case one charger,
charging the at least two electric energy stores with in each case one charging power assigned to the respective charger, and
performing closed-loop control with respect to the charging powers, wherein
   the instantaneous charging power of each charger is determined,
   the instantaneous charging powers are added to give an instantaneous total charging power,
   the instantaneous total charging power is compared with a predefined upper charging power limit, and
   at least one of the charging powers assigned to the respective chargers is reduced when the instantaneous total charging power is greater than the predefined upper charging power limit.

First, at least two electric energy stores to be charged are connected to in each case one charger. The at least two electric energy stores are charged with a charging power assigned to the respective charger. The essence of the invention consists in that the charging powers are subjected to closed-loop control. For this purpose, the instantaneous charging power of each charger is determined. The instantaneous charging powers are added to give an instantaneous total charging power, which is compared with a predefined upper charging power limit. When the instantaneous total charging power is greater than the predefined upper charging power limit, at least one of the charging powers assigned to the respective chargers is reduced. The reduction in at least one of the charging powers limits the total charging power. As a result, undesired peak loads can be reduced and in particular prevented even at times of high load demands, for example during shift changes. For example, the total charging power can be kept reliably below a mains connection power. This increases safety and reduces the running costs during charging of the electric energy stores.

The charging powers of the respective chargers are proportional to the charging current assigned to the respective chargers. This charging current comprises the current for supply to the charger and the electrical charge output to the electric energy store per unit time.

The charging powers and therefore also the total charging power are controlled variables of the method according to the invention. The instantaneous charging powers and the instantaneous total charging power calculated therefrom are the actual variables to be determined. The upper charging power limit represents a limit value for the closed-loop control.

The closed-loop control can take place in a plurality of control loops, in particular in periodically repeating control loops. For example, the charging powers of the individual chargers can be determined, in particular read out, successively. The readout of the chargers preferably takes place by means of a multiplex method. After readout of the individual chargers, a closed-loop control step can then take place. The setpoint variables determined in the closed-loop control step can be transmitted to the chargers during the closed-loop control step. Preferably, however, the setpoint variables are transmitted to the chargers during readout of the charging powers in the next control loop. Such parallel transmission and readout is particularly efficient and can preferably be realized by means of the multiplex method.

For example, two successive control loops can have a fixed time interval. In particular in the case of sequential readout of the chargers, the time interval of the control loops can be dependent on the number of chargers. The control loop is preferably repeated after the sequential readout of all of the chargers and the closed-loop control step. A period determined by the periodic repetition of the control loop can result in particular from the product of the number of the chargers and a readout duration which is required for determining the charging power of an individual charger. The period is inversely proportional to a sampling rate which is realized by the repeating control loops. The readout duration may be the same for all of the chargers and may be in particular between 10 ms and 100 ms, in particular between 20 ms and 50 ms, preferably approximately 25 ms. As a result, quick and at the same time precise determination of the charging powers of the respective chargers is possible.

The reduction in the charging power of at least one of the chargers can take place continuously or at fixed power levels. In this case, it is in particular also possible for individual ones of the chargers to be temporarily switched off.

The implementation of the method, in particular the control loop, can take place using a closed-loop control unit. The closed-loop control unit can be connected to the respective chargers in such a way as to be capable of transmitting data. The closed-loop control unit can, for example, read out the instantaneous actual variables from the chargers and transmit control commands to the respective chargers.

The chargers may be separate from one another or else may merely be individual terminals of a common charging station. The chargers can be combined in different charger groups, each having at least two chargers, wherein a first upper charging power limit can be preset for each charger group. The upper charging power limits of the individual charger groups give in total a total charging power limit. Alternatively, provision can also be made for only the upper total charging power limit to be preset. The chargers are suitable in particular for charging drive batteries for in-plant industrial trucks, in particular stacker trucks and/or fork-lift trucks. The individual chargers can, however, also be used for charging different types of electric energy stores.

Electric energy stores are understood to mean all known storage devices for electrical energy. The electric energy stores are preferably batteries, in particular batteries for mobile industrial applications, in particular drive batteries for in-plant industrial trucks. Preferably, at least one of the energy stores to be charged, in particular one of the batteries, in particular one of the drive batteries, is removed for charging purposes from the respective equipment to which current is to be supplied, in particular the respective mobile industrial application, in particular from the respective in-plant industrial truck. The method can in particular have a removal step for removing the energy stores to be charged from equipment to which current is to be supplied in each case, in particular from the respective mobile industrial application, in particular from the respective in-plant industrial truck.

The connection of the electric energy stores to in each case one charger is intended to mean the establishment of a connection for energy transmission from the charger to the electric energy store. This may take place in any known way. For example, an electrical connection can be produced via a power cable and/or a male connector contact. Alternatively, a wireless link can be provided for wirelessly charging the electric energy stores.

Preferably, the charging of the electric energy stores takes place using a DC charging method. The connection of the electric energy stores takes place in particular via a DC terminal.

Particularly preferably, the charging of the electric energy stores takes place in the low-voltage range, in particular in the low-voltage range of up to 120 V. The voltage in the low-voltage range of up to 120 V is also referred to as extra-low voltage.

In accordance with a preferred embodiment of the method, the upper charging power limit is between 75% and 99.5%, in particular between 80% and 99%, in particular between 85% and 95%, preferably approximately 90% of a maximum charging power. By selecting such an upper charging power limit, a situation whereby the maximum charging power is exceeded is reliably avoided. As a result, a safe charging method which reliably prevents peak loads is ensured. The maximum charging power may correspond, for example, to a mains connection power which is available for charging the electric energy stores. The selected upper charging power limit also enables, in addition to safe performance of charging, good capacity utilization of the maximum charging power available.

The maximum charging power can be preset, for example, by the energy supplier, an energy supply contract, in-plant power supply infrastructures and/or operational defaults. The upper charging power limit is less than the maximum charging power. It is determined in particular by the maximum charging power minus a safety offset.

In accordance with a further preferred embodiment of the method, at least one of the charging powers is reduced stepwise from a rated power, which is provided for charging the respective electric energy store. The stepwise reduction in the at least one charging power ensures an effective, quick-response and safe method. For example, different power levels which depend on the respective rated power can be used for operating the chargers.

The rated power may be dependent on the electric energy store and/or the respective charger. It may be the same or else different for all of the electric energy stores to be charged. The rated power can be stored centrally, for example in a closed-loop control unit. Alternatively, the rated power can be determined together with the instantaneous charging powers during closed-loop control, in particular read out from the respective charger.

In accordance with a further preferred aspect of the invention, at least one of the charging powers is increased as soon as the instantaneous total charging power falls below a lower charging power limit, wherein the lower charging power limit is less than the upper charging power limit. As a result, safe and at the same time quick charging is ensured. In particular, the maximum power is effectively exhausted without there being any threat of the maximum power being exceeded. The lower charging power limit is determined, for example, by the maximum power minus a capacity utilization offset.

Preferably, a charging power which has been reduced previously owing to the closed-loop control of the charging powers is increased when the lower charging power limit is undershot. The increase in the charging power preferably takes place in the same way as the reduction thereof, stepwise, until the respective rated power is reached. For this purpose, provision can be made for the power levels at which the chargers are operated in each case to be determined, in particular read out, together with the instantaneous charging powers.

In accordance with a further advantageous aspect of the invention, the lower charging power limit is between 50% and 95%, in particular between 60% and 90%, in particular between 70% and 80%, preferably approximately 75% of the maximum charging power. This enables particularly effective capacity utilization of the maximum charging power. In a particularly preferred embodiment of the method, the lower charging power limit is determined by the difference between the upper charging power limit minus the rated power of one or more of the chargers. This procedure is particularly advantageous if more than two chargers, in particular more than three chargers, in particular more than four chargers, in particular more than five chargers, in particular more than 10 chargers are charged, each with the same rated power, using the method. In such a case, provision can be made in particular for the lower charging power limit to be the same as the upper charging power limit minus twice the rated power of one of the chargers.

In accordance with a further preferred aspect of the invention, the closed-loop control of the charging powers takes place depending on the states of charge of the respective electric energy stores. The efficiency of the charging of an electric energy store may be dependent on the respective state of charge. Including the states of charge as an actual variable in the closed-loop control ensures particularly efficient charging of the electric energy stores. The respective state of charge (SOC) can be measured as a percentage of the charging capacity of the respective electric energy store. The respective states of charge can be determined, in particular read out, together with the charging powers, for example.

Particularly preferably, the electric energy stores are categorized into different priority classes depending on the state of charge.

In accordance with a further preferred aspect of the invention, when the upper charging power limit is exceeded, first the charging power for at least one of the at least two electric energy stores whose state of charge is higher than the state of charge of the other electric energy stores is reduced. When the electric energy stores are categorized into different priority classes, electric energy stores with a low state of charge can be categorized in particular into higher priority classes than those with a high state of charge. Such a method is particularly efficient, in particular since electric energy stores can be charged at a low state of charge with few power losses. The prioritization of electric energy stores with a low state of charge additionally ensures that all of the electric energy stores to be charged are charged to a minimum state of charge, for example 30% of the respective charging capacity, in as short a time as possible. Thus, a bottleneck at electric energy stores can be passed at least temporarily.

Preferably, the charging power of at least one of the electric energy stores is dynamically throttled and/or redistributed when the upper charging power limit is exceeded. The prioritization, in particular the categorization into different priority classes, guarantees in particular as high an efficiency as possible of the electric energy stores to be charged. The electric energy store(s) with the lowest state of charge become apportioned the highest charging power. Advantageously, the maximum charging power is not exceeded and at the same time charging of the electric energy stores which is as quick as possible is effected.

In accordance with a further preferred aspect of the invention, the upper charging power limit and/or the lower charging power limit are fixed variably, in particular in a manner dependent on the time of day. Such a charging method is particularly cost-effective and flexible. For example, a user can preset the upper and/or the lower charging power limit manually.

Alternatively or additionally, a variable, in particular use-dependent or time-of-day-dependent, maximum charging power can be preset, wherein the charging power limits are based on the variable maximum charging power. Furthermore, the safety offset and/or the capacity utilization offset can be varied depending on demand.

In accordance with a further preferred aspect of the invention, a time characteristic of the previously determined charging powers is determined. The time characteristic can be displayed, for example, to a user on an external device and/or on the closed-loop control unit. The determined time characteristic is also referred to as “trending”. This enables precise supervision and user-side monitoring of the charging method. The charging method, in particular the connection of further energy stores, can be planned particularly easily. This increases safety when charging the electric energy stores.

Particularly preferably, the trending also takes place for the further operational parameters, such as, for example, the instantaneous states of charge, priority classes and/or power levels. As a result, comprehensive monitoring and analysis of the charging method by a user is possible.

A further object of the invention consists in providing an improved device for charging electric energy stores, in particular producing a device with which peak powers can be reduced.

This object is achieved by a device for charging electric energy stores, having
at least two chargers for charging in each case one electric energy store with in each case one charging power assigned to the respective charger and
a closed-loop control unit,
   wherein the closed-loop control unit is configured to perform closed-loop control with respect to the charging powers of the respective chargers used for charging during charging of at least two electric energy stores, which are each connected to one of the at least two chargers, wherein:
the instantaneous charging power of each of the chargers used for charging the at least two electric energy stores is determined,
the instantaneous charging powers are added to give a total charging power, and
the instantaneous total charging power is compared with a predefined upper charging power limit, and
at least one of the charging powers assigned to the respective chargers is reduced when the instantaneous total charging power is greater than the predefined upper charging power limit.

The device comprises at least two chargers for charging in each case one electric energy store with in each case one charging power assigned to the respective charger. In addition, a closed-loop control unit is provided. The closed-loop control unit is configured to perform closed-loop control with respect to the charging powers of the respective chargers used for charging during charging of at least two electric energy stores, which are each connected to one of the at least two chargers, in accordance with the above-described method. The advantages of the device become clear from the advantages of the method described above.

The device may have a large number of chargers. Preferably, electric energy stores are charged via all of the chargers. However, it is also possible for individual ones of the chargers contained in the device not to be used for charging an electric energy store. The unused chargers do not consume any charging power and are not included in the closed-loop control.

The electric energy stores are not part of the device but can merely be connected to the chargers of the device for the purposes of being charged. The closed-loop control by means of the closed-loop control unit takes place as soon as at least two electric energy stores are connected to in each case one of the chargers of the device. For example, the electric energy stores are connectable to the charging stations via a terminal on the equipment to which current is to be supplied in each case, in particular on the respective mobile industrial application, in particular on the respective in-plant industrial truck. Preferably, the electric energy stores are removed from the respective equipment, in particular the respective mobile industrial application, in particular the respective in-plant industrial truck, for connection to the chargers.

Preferably, the device is suitable for implementing a DC charging method. In particular, the chargers have a DC terminal for connecting an electric energy store.

Preferably, the device is configured for charging electric energy stores in the low-voltage range, in particular in the low-voltage range of up to 120 V.

In accordance with a preferred embodiment of the device, an interface for inputting operational parameters is provided. For example, the maximum charging power and the upper or lower charging power limit can be input via the interface. The interface preferably makes available a connection via a network, in particular a wireless network, to the closed-loop control unit. Therefore, the input can take place, for example, on a user device via an app or a web browser. Alternatively, the interface can be configured for connecting dedicated input devices, in particular a keyboard or a touchscreen, to the closed-loop control unit.

In accordance with a further preferred embodiment of the device, at least two charger groups, each having at least two chargers, are provided, wherein the closed-loop control of the charging powers takes place independently of one another for both charger groups. In particular, a dedicated maximum charging power and a dedicated upper and/or lower charging power limit are preset for each charger group. The total charging power is determined independently for each charger group. The provision of different charger groups provides the possibility of a high degree of flexibility of the device. For example, the different charger groups can be assigned to different electrical terminals. Also, different types of electric energy store can be charged using the different charger groups.

The chargers of the device are categorized into the different charger groups. This categorization can be fixedly preset or variable. For example, different charger groups can be formed depending on the energy stores to be charged and the electrical terminals available in order to make optimum use of preset mains connection voltages.

In accordance with a further preferred aspect of the invention, the device may have a modular design. This means that, for example, the number of chargers and/or charger groups can be matched flexibly to the respective requirement. The device is in particular expandable. In addition, a modular design enables easy replacement of defective and/or outdated chargers.

In order to provide a modular device, provision can be made, for example, for the closed-loop control unit not to be connected directly to the chargers but via a data link. It has proven to be particularly suitable in this case for there to be a wireless data link, in particular a WLAN link. Particularly preferably, a WPAN (Wireless Private Area Network), in particular an 868 MHz WPAN, is used for the wireless communication between the chargers and the closed-loop control unit. As an alternative to the wireless data link, a wired data link, in particular in accordance with the standard RS485, can be used. This enables a particularly flexible design of the device. In particular, the arrangement of the chargers and the closed-loop control unit can be matched to the respective physical conditions.

Preferred embodiments of the invention will be described by way of example below with reference to the attached drawings.

### BRIEF DESCRIPTION OF THE DRAWINGS

FIG. 1 shows a schematic illustration of a modular device for charging electric energy stores,

FIG. 2 shows a schematic method sequence for charging electric energy stores, and

FIG. 3 shows a time characteristic of the charging powers during charging of three electric energy stores in accordance with the method shown in FIG. 2.

### DESCRIPTION OF THE PREFERRED EMBODIMENT

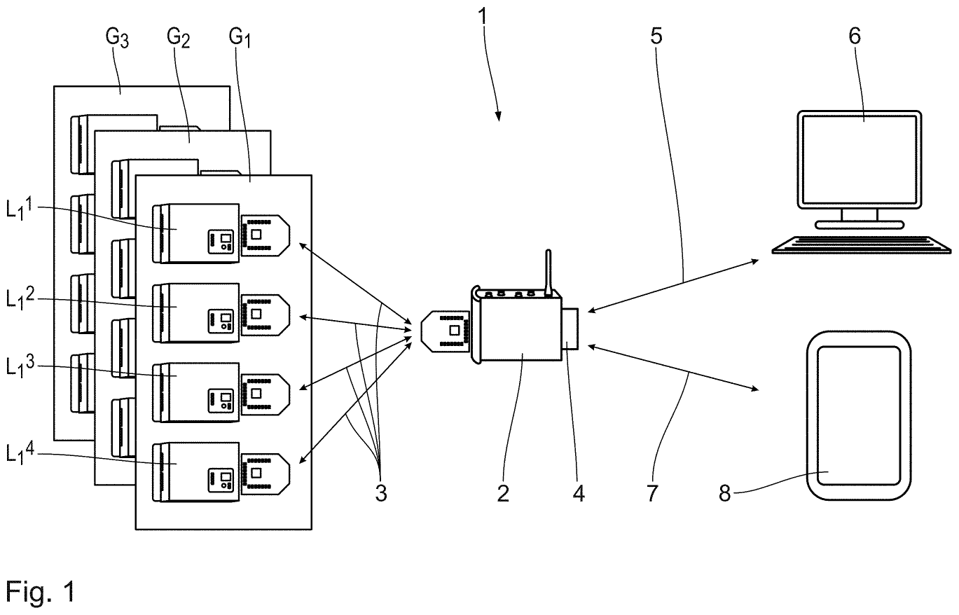

FIG. 1 shows a schematic design of a charging device 1 for charging electric energy stores. The central component of the charging device 1 is a closed-loop control unit 2. The closed-loop control unit 2 is a so-called NBG control unit.

The charging device 1 comprises a plurality of chargers Lⱼⁱ which are divided into various charger groups Gⱼ. The index j=1, 2, . . . in this case numbers consecutively the different charger groups Gⱼ. The charger Lⱼⁱ is assigned to the charger group Gⱼ. The index i=1, 2, . . . numbers consecutively the chargers Lⱼⁱ in the respective charger group Gⱼ. The charging device 1 shown in FIG. 1 has three charger groups Gⱼ (j=1, 2, 3), each having four chargers Lⱼⁱ (i=1, 2, 3, 4). Exemplary embodiments having more or fewer, in particular only one charger group Gⱼ are of course also conceivable. In addition, different numbers of chargers Lⱼⁱ can be provided for each charger group Gⱼ. The individual chargers Lⱼⁱ are embodied independently of one another as different component parts. In other exemplary embodiments, at least some of the chargers Lⱼⁱ can be embodied as individual terminals of a common charging station.

The individual chargers Lⱼⁱ are each connected to the closed-loop control unit 2 in data-transmitting fashion via the data links 3. The data link 3 serves to transmit operational data of the chargers Lⱼⁱ to the closed-loop control unit 2 and control commands from the closed-loop control unit 2 to the respective chargers Lⱼⁱ. The data links 3 may be conventional wired data links, for example in accordance with the standard RS485.

Alternatively, the data link 3 is provided wirelessly. This can take place using any desired local or remote communication means, such as, for example, Bluetooth, W-LAN or mobile radio networks. In the preferred exemplary embodiments, the wireless data link takes place via an 868 MHz WPAN.

Owing to the flexibly configurable data links 3, the chargers Lⱼⁱ are connected flexibly to the closed-loop control unit 2. In this way, more or fewer chargers Lⱼⁱ can be connected to the closed-loop control unit 2. Owing to the flexible configuration, the charging device 1 has a modular design. The charging device 1 can be used flexibly for charging different numbers of electric energy stores.

The charging of the electric energy stores takes place in such a way that the chargers Lⱼⁱ to which in each case one energy store is connected charge the relevant energy store with a charging power pⱼⁱ assigned to the respective charger Lⱼⁱ. The charging power pⱼⁱ corresponds to the power consumption of the respective charger Lⱼⁱ for charging the energy store. The charging power pⱼⁱ is proportional to a charging current, which in turn consists of the current for supply to the respective charger Lⱼⁱ and the charging power transmitted to the electric energy store per unit time. The charging power is less than or equal to a rated power Nⱼⁱ which is provided for charging the respective electric energy store.

The chargers are designed for charging drive batteries for in-plant industrial trucks. High charging currents are required for charging the drive batteries, i.e. the respective charging powers pⱼⁱ and rated powers Nⱼⁱ are high. At certain times, in particular during shift changes, peak loads can occur since many of the chargers are used simultaneously for charging drive batteries. These peak loads can exceed mains connection powers. This can result in high running costs.

In order to prevent and avoid such peak loads, the closed-loop control unit 2 subjects the charging of the electric energy stores by means of the chargers Lⱼⁱ to closed-loop control. The closed-loop control takes place independently of one another for the individual charger groups Gⱼ. In this case, the instantaneous charging powers pⱼⁱ of the chargers Lⱼⁱ of each charger group Gⱼ are added to give a total charging power Pⱼ of the respective charger group Gⱼ. The closed-loop control ensures that the total charging power Pⱼ does not exceed a maximum charging power Mⱼ allocated to the respective charger group Gⱼ. An upper charging power limit Oⱼ and a lower charging power limit Uⱼ are defined for each charger group Gⱼ. The maximum charging power the upper charging power limit Oⱼ and the lower charging power limit Uⱼ are limit values for the closed-loop control of the charging powers pⱼⁱ.

The maximum charging power Mⱼ is generally an externally preset upper limit. This can be set, for example, by the mains connection power. The charging power limits Oⱼ, Uⱼ are matched to the respective maximum charging power Mⱼ and are less than said maximum charging power. The upper charging power limit Oⱼ is generally determined by the maximum charging power Mⱼ minus a safety offset. It has proven to be practicable if the upper charging power limit Oⱼ is between 75% and 99.5%, in particular between 80% and 99%, in particular between 85% and 95%, preferably approximately 90% of the maximum charging power. The lower charging power limit Uⱼ is less than the upper charging power limit Q. It is determined from the maximum charging power Mⱼ minus a capacity utilization offset. It has proven to be practicable to select the lower charging power limit Uⱼ to be between 50% and 95%, in particular between 60% and 90%, in particular between 70% and 80%, preferably approximately 75% of the maximum charging power Mⱼ.

The closed-loop control unit 2 has an interface 4. Operational parameters for charging the electric energy stores can be transmitted to the closed-loop control unit 2 via the interface 4. For this purpose, the interface 4 comprises a LAN link 5 to a computer 6. The operational parameters can be transmitted to the closed-loop control unit 2 via the computer 6. In addition, the operational data can be read out and displayed by means of the computer 6. In addition to or as an alternative to the LAN link 5, the interface 4 provides a wireless link 7 to a mobile terminal device 8. The mobile terminal device 8 may be, for example, a tablet or a smart phone. Operational parameters can also be transmitted to the closed-loop control unit 2 and/or operational data read from said closed-loop control unit 2 via the mobile terminal device 8. The operational parameters can be fixed in a manner dependent on the time of day or consumption. They include the upper charging power limit Oⱼ, the lower charging power limit Uⱼ and the maximum charging power Mⱼ for each charger group Gⱼ. The operational data which can be read out include the instantaneous charging powers pⱼⁱ, the instantaneous total charging power Pⱼ and/or states of charge Zⱼⁱ of the electric energy stores to be charged in each case. The operational data can be displayed and evaluated on the computer 6 and/or the mobile terminal device 8.

The limit values maximum charging power upper charging power limit Oⱼ and lower charging power limit Uⱼ are fixed independently of one another for the individual charger groups Gⱼ. In addition, the closed-loop control unit 2 subjects the charging method for the individual charger groups Gⱼ to closed-loop control independently of one another. For the more detailed illustration of the charging method, therefore, reference will be made below to only one charger group Gⱼ.

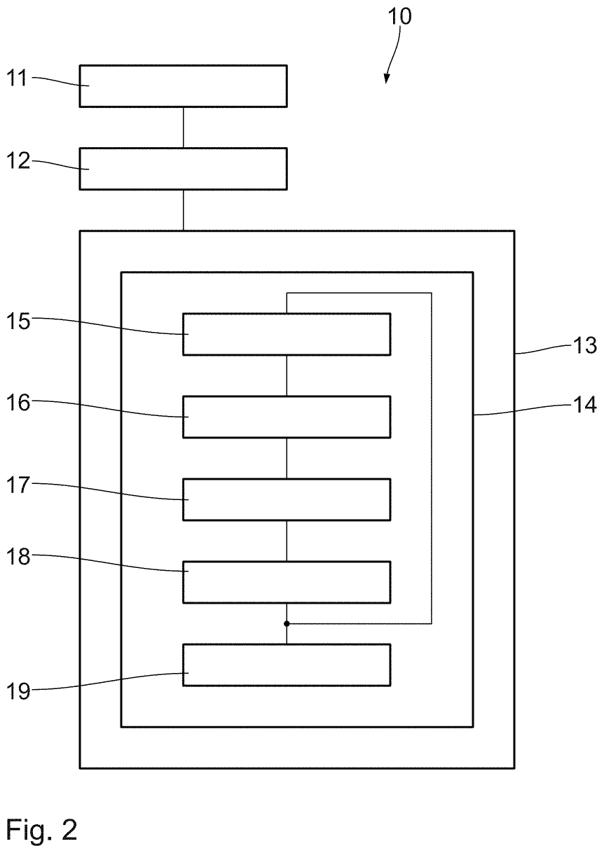

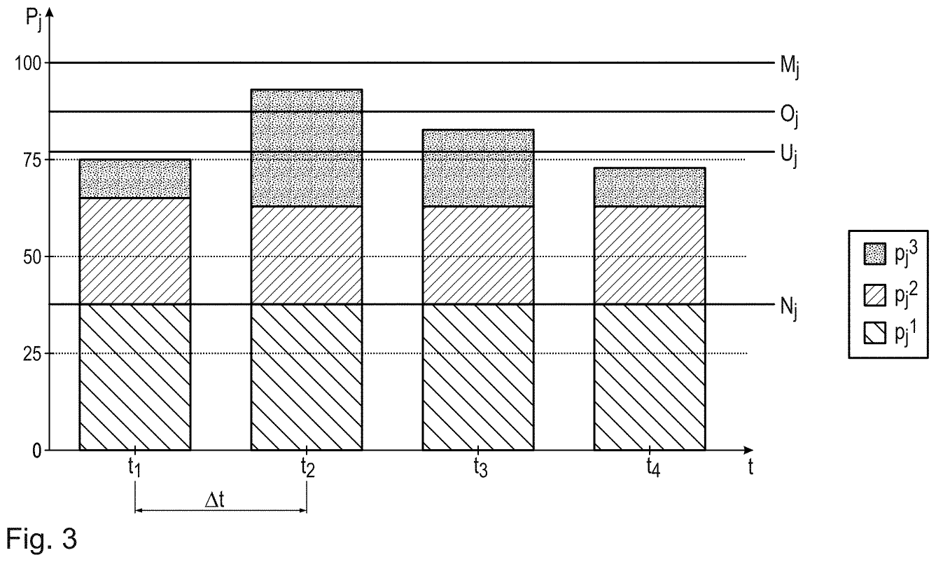

The method for charging the electric energy stores will be described in detail below with reference to FIGS. 2 and 3. FIG. 2 shows a schematic sequence of a charging method 10 with the aid of the charging device 1.

First, in a calibration step 11, the operational parameters for the charging method 10 are transmitted to the control unit 2. As a result, the limit values maximum charging power upper charging power limit Oⱼ and lower charging power limit Uⱼ are fixed. The limit values can be input, for example, via the computer 6 or the mobile terminal device 8 and transmitted to the closed-loop control unit 2 via the interface 4. The limit values fixed by the user may be variable. The charging power limits Oⱼ, Uⱼ and the maximum charging power Mⱼ can be defined in a manner dependent on the time of day, for example. As a result, energy costs and/or mains connection powers which are dependent on the time of day can be taken into consideration. It is also possible for other operationally related peak loads to be taken into consideration by fixing a lower maximum charging power Mⱼ and correspondingly lower charging power limits Oⱼ, Uⱼ.

In a connection step 12 following on from the calibration step 11, the electric energy stores to be charged are connected to the respective chargers Lⱼⁱ. In this case, connection is understood to mean that a connection for energy transmission is established between the respective charger Lⱼⁱ and the respective electric energy store. In the simplest case, this is a conventional electrical plug connection. Alternatively, a wireless link for wireless charging can also be provided in the connection step 12. In further exemplary embodiments which are not illustrated, a removal step is performed prior to the connection step 12, in which removal step the electric energy stores are removed from the respective in-plant industrial truck. In these exemplary embodiments, the electric energy stores are connected to the chargers Lⱼⁱ independently of the respective industrial trucks.

The electric energy stores connected to the respective chargers Lⱼⁱ in the connection step 12 are then charged with electrical energy in a charging step 13. In this regard it will be mentioned that there is no strict time separation between the connection step 12 and the charging step 13. Instead, it is also possible for further electric energy stores to be connected to previously unused chargers Lⱼⁱ in the connection step 12 while the charging step 13 is already being performed for other electric energy stores with the aid of the respective chargers Lⱼⁱ.

During the charging step 13, the electric energy stores are charged with the charging power pⱼⁱ assigned to the respective charger Lⱼⁱ. The respective charging powers pⱼⁱ are subjected to closed-loop control by the closed-loop control unit 2 in a control loop 14 during the charging step 13.

In the charging step 13, the electric energy stores are charged by the respective charger Lⱼⁱ preferably with a charging power pⱼⁱ which corresponds to the rated power Nⱼⁱ. The charging preferably takes place by DC charging in the low-voltage range of up to 120 V. The closed-loop control unit 2, via the control loop 14, can fix the charging power pⱼⁱ of the respective chargers Lⱼⁱ independently of one another, in particular can throttle said charging power to a value below the rated power Nⱼⁱ. The throttling of the charging powers pⱼⁱ of the chargers Lⱼⁱ takes place in six power levels Sⱼⁱ. The power levels Sⱼⁱ are listed in Table 1, wherein a percentage of the rated power Nⱼⁱ is assigned to each power level Sⱼⁱ. The respective percentage of the rated power Nⱼⁱ corresponds to the charging power pⱼⁱ with which the respective charger Lⱼⁱ charges the connected electric energy store in accordance with the set power level Sⱼⁱ. The highest power level Sⱼⁱ=5 corresponds to operation of the charger at the rated power Nⱼⁱ. The lowest power level Sⱼⁱ=0 corresponds to temporary shutdown of the charger Lⱼⁱ or a break in charging.

TABLE 1
The charging powers pⱼⁱ assigned to the respective power levels
Sⱼⁱ as a percentage of the respective rated power Nⱼⁱ

| | Charging power pⱼⁱ as a percentage |
|---|---|
| Power level Sⱼⁱ | of the rated power Nⱼⁱ |
| 0 | 0 |
| 1 | 10 |
| 2 | 25 |
| 3 | 50 |
| 4 | 75 |
| 5 | 100 |

The charging of the electric energy stores connected to the respective chargers Lⱼⁱ proceeds all the more quickly the higher the power level Sⱼⁱ at which the charger Lⱼⁱ is operated. In addition to this, the present state of charge Zⱼⁱ of the respective electric energy store influences the efficiency of the charging. The state of charge Zⱼⁱ specifies the percentage of the charging capacity to which the respective energy store has been charged. In order to ensure charging which is as effective as possible, the chargers Lⱼⁱ are categorized into four priority classes in accordance with the respective state of charge Zⱼⁱ of the connected electric energy stores. The four priority classes are illustrated in Table 2. Chargers in the lowest priority class (priority class 1) have a high state of charge Zⱼⁱ. Conversely, the state of charge Zⱼⁱ for the higher priority classes, in particular the highest priority class (priority class 4), is lower.

TABLE 2
Categorization of the chargers Lⱼⁱ into priority
classes in accordance with the state of charge
Zⱼⁱ of the respectively connected energy store

| Priority class | State of charge Zⱼⁱ | Minimum power level Sⱼⁱ |
|---|---|---|
| 1 | 70% to 100% | 1 |
| 2 | 50% to 70% | 2 |
| 3 | 30% to 50% | 3 |
| 4 | 0% to 30% | 5 |

The higher the state of charge Zⱼⁱ, the less effective the charging of the electric energy store is. In the case of a limited maximum charging power Mⱼ, it is therefore advantageous to supply the electric energy stores with a low state of charge Zⱼⁱ preferably with high charging powers pⱼⁱ. For example, the chargers Lⱼⁱ in priority class 1 can be operated at the power level Sⱼⁱ=1. Conversely, it is advantageous to operate chargers Lⱼⁱ in the highest priority class (priority class 4) at the respective maximum rated power Nⱼⁱ, i.e. power level Sⱼⁱ=5, for as long as possible. Therefore, if throttling is required, first those chargers Lⱼⁱ which are assigned to the lowest priority class are throttled. Only when all of the chargers Lⱼⁱ in a lower priority class are being operated at a minimum power level Sⱼⁱ assigned to the respective priority class does the throttling also take place for chargers Lⱼⁱ in higher priority classes. The minimum power levels Sⱼⁱ for the respective priority classes are specified in Table 2.

The individual steps of the control loop 14 will be explained below. First, the closed-loop control unit 2 reads out, in a readout step 15, instantaneous operational data of the chargers Lⱼⁱ. In this process, the instantaneous charging power pⱼⁱ of each charger Lⱼⁱ is determined via the data link 3. In the readout step 15, in addition the respectively set power level Sⱼⁱ and the rated power Nⱼⁱ and the state of charge Zⱼⁱ of the electric energy store connected to the charger Lⱼⁱ are transmitted to the closed-loop control unit 2. The instantaneous operational data read out in the readout step 15 are actual variables of the control loop.

In the readout step 15, the instantaneous charging powers pⱼⁱ of each charger Lⱼⁱ are read out successively. The transmission of the instantaneous operational data takes place in a multiplex method. For this purpose, a readout duration is provided for each charger Lⱼⁱ. The readout duration is usually 25 ms. In other exemplary embodiments, other readout durations can also be provided. The multiplex method additionally makes it possible for data, for example setpoint variables, to also be transmitted from the closed-loop control unit 2 to the respectively read charger Lⱼⁱ in the readout step 15, as will be described further below.

The readout step 15 is followed by a calculation step 16. In the calculation step 16, the closed-loop control unit 2 determines the instantaneous total charging power Pⱼ by virtue of the instantaneous charging powers pⱼⁱ of all of the chargers Lⱼⁱ in a charger group Gⱼ being added.

In a subsequent comparison step 17, the instantaneous total charging power Pⱼ determined in the calculation step 16 is compared with the limit values upper charging power limit Oⱼ, lower charging power limit Uⱼ and the maximum charging power Mⱼ.

The comparison step 17 is followed by a closed-loop control step 18. In the closed-loop control step 18, the closed-loop control unit 2 determines, depending on the result of the comparison step 17, necessary adaptations of the charging powers pⱼⁱ. In the closed-loop control step 18, the setpoint variables for the closed-loop control are determined.

The determined setpoint variables can be transmitted directly in the closed-loop control step 18 to the respective chargers Lⱼⁱ. In the charging method 10 illustrated in FIG. 2, however, only the setpoint variables are calculated in the closed-loop control step 18. Following the closed-loop control step 18, the control loop 14 is repeated by virtue of a readout step 15 being performed again. Transmission of the setpoint variables in the closed-loop control step 18 to the chargers Lⱼⁱ is therefore not necessary in the closed-loop control step 18. In the readout step 15 of the subsequent control loop 14, owing to the multiplex method used for this purpose, transmission of the setpoint variables determined in the closed-loop control step 18 of the preceding control loop 14 can also take place in addition to readout of the instantaneous actual variables. The sampling rate is thus increased. This ensures quick-response and efficient closed-loop control of the charging powers pⱼⁱ.

Various measures taken by the closed-loop control unit 2 for adapting the charging powers pⱼⁱ will be described by way of example in the text which follows.

For the case where the instantaneous total charging power Pⱼ is greater than the upper charging power limit Oⱼ, at least one of the charging powers pⱼⁱ assigned to the respective chargers Lⱼⁱ is reduced. This means that the power level Sⱼⁱ of at least one of the chargers Lⱼⁱ is reduced. As a result, the possibility of the upper charging power limit Oⱼ being permanently exceeded is consistently prevented. The throttling takes place depending on the percentage of the maximum charging power Mⱼ by which the upper charging power limit Oⱼ is exceeded. In this case, first the charging powers pⱼⁱ of those chargers Lⱼⁱ which are assigned to the lowest priority class are throttled. Only when all of the chargers Lⱼⁱ in the lowest priority class are being operated at the respective minimum power level Sⱼⁱ does throttling also take place for chargers Lⱼⁱ in the next higher priority class.

Owing to the throttling, the maximum charging power Mⱼ is generally not reached or exceeded. If the comparison step 17 should give the result that the maximum power Mⱼ has nevertheless been exceeded, charging with the chargers Lⱼⁱ in the low priority levels is first interrupted by virtue of the power level Sⱼⁱ=0 being set. Then, the charging powers pⱼⁱ of the relevant chargers are increased gradually, thereby ensuring that the maximum charging power Mⱼ is not exceeded.

If the comparison step 17 gives the result that the instantaneous total charging power Pⱼ falls below the lower charging power limit Uⱼ, the charging power pⱼⁱ of at least one of the chargers is increased if not all of the chargers Lⱼⁱ connected to an electric energy store to be charged are already being operated at the respective rated power Nⱼⁱ, i.e. the power level Sⱼⁱ=5. If appropriate, the charging power pⱼⁱ first of those chargers Lⱼⁱ which are assigned to a high priority class is increased. If all of the chargers Lⱼⁱ are already being operated at the respective maximum rated power Nⱼⁱ, there is no increase in the charging powers pⱼⁱ.

If the comparison step 17 gives the result that the instantaneous total charging power Pⱼ is less than or equal to the upper charging power limit Oⱼ and at the same time greater than or equal to the lower charging power limit Uⱼ (Oⱼ>Pⱼ>Uⱼ), the charging powers pⱼⁱ of the chargers Lⱼⁱ remain unchanged.

After the closed-loop control step 18, the control loop 14 is repeated by virtue of a readout step 15 being performed again. The control loop 14 is repeated periodically throughout the charging step 13. In this case, the control loop 14 is repeated with a fixed time interval Δt. The time interval Δt is dependent on the number of chargers Lⱼⁱ. The time interval Δt results from the number of chargers Lⱼⁱ multiplied by the readout duration which is required for the readout of each charger. The time interval corresponds to a period, which results in a sampling rate realized by the periodic repetition of the control loop 14.

FIG. 3 shows the time characteristic of the total charging power Pⱼ of three chargers Lⱼⁱ in a charger group Gⱼ which are connected to an energy store to be charged for four control loop periods, i.e. for four times tk (k=1, 2, 3, 4). The total charging power Pⱼ is plotted as a percentage of the maximum charging power Mⱼ. The charging of the energy stores connected to the chargers Lⱼⁱ takes place in accordance with the charging method 10.

The chargers Lⱼⁱ are each embodied identically and have the same maximum rated power Nⱼⁱ (Nⱼ in the figure and below). Exemplary values for the rated power Nⱼ, the upper charging power limit Oⱼ and the lower charging power limit Uⱼ are shown in FIG. 3.

The state of charge Zⱼⁱ of the electric energy store connected to the charger Lⱼⁱ is between 0% and 30%. The charger Lⱼⁱ is therefore assigned to priority class 4. The chargers Lⱼ² and Lⱼ³ each have a state of charge Zⱼ², Zⱼ³ of between 30% and 50% and are assigned to priority class 3.

At time t₁, the charging powers pⱼⁱ of the three chargers Lⱼⁱ are read out. The charger Lⱼⁱ in priority class 4 is operated at the rated power Nⱼ, i.e. at the highest power level Sⱼ¹=5. The charger Lⱼ² is operated at the power level Sⱼ²=4, i.e. at 75% of the rated power Nⱼ. The charging power pⱼ³ of the charger Lⱼ³ merely corresponds to the power level Sⱼ³=1, i.e. 25% of the maximum rated power Nⱼ. The instantaneous total charging power Pⱼ at time t₁ is below the lower charging power limit Uⱼ. The closed-loop control unit 2 therefore increases the charging power pⱼ³ of the charger Lⱼ³.

After a time interval Δt, in the next control loop 14 at time t₂ the instantaneous charging powers pⱼⁱ of the three chargers Lⱼⁱ are read out again in the readout step 15. Owing to the increase in the charging power pⱼ³ of the charger Lⱼ³ in the preceding control loop, said charger is now operated at the power level Sⱼ³=4. The total charging power Pⱼ at time t₂ exceeds the upper charging power limit Oⱼ. Therefore, the closed-loop control unit 2 again throttles the charging power pⱼ³ of the charger Lⱼ³ by a power level Sⱼ³ to Sⱼ³=3. The readout step 15 of the following control loop at time t₃ therefore gives the result that the charger Lⱼ³ is being operated at a charging power pⱼ³ of 50% of the maximum rated power Nⱼ, i.e. at the power level Sⱼ³=3. For this case, the instantaneous total charging power Pⱼ at time t₃ is less than the upper charging power limit Oⱼ and greater than the lower charging power limit Uⱼ. The closed-loop control unit 2 will leave the charging powers pⱼⁱ of the three chargers Lⱼⁱ unchanged in the closed-loop control step 18 of the control loop at time t₃.

The instantaneous charging powers pⱼⁱ can, however, also vary independently of the closed-loop control unit 2 owing to external influences. Such variations are identified by the readout step 15 of each control loop 14. For example, between times t₃ and t₄, the instantaneous charging power pⱼ³ of the charger Lⱼ³ is reduced in response to external influences. This is reflected in the instantaneous total charging power Pⱼ which is read out and calculated at time t₄. The closed-loop control unit 2 can respond to such external influences by virtue of the respective charging powers pⱼⁱ being matched thereto. In the present case, the closed-loop control unit 2 will increase the charging power pⱼ³ of the charger Lⱼ³.

In addition, the control loop 14 comprises a trending step 19. In the trending step 19, a time characteristic of the previously read-out actual variables, inter alia the previously read-out charging powers pⱼⁱ, is determined. This time characteristic is displayed to the user on the computer 6 and/or the mobile terminal device 8. The user can evaluate the time characteristics of the actual variables and thereby check the method and possibly also take control measures.

For example, if the time characteristic of the instantaneous charging powers pⱼⁱ shows that the total charging power Pⱼ is close to the upper charging power limit Oⱼ over a relatively long period of time, the user can dispense with the connection of further energy stores to previously free chargers Lⱼⁱ. Alternatively, in order nevertheless to connect further energy stores to free chargers Lⱼⁱ, the user can manually force throttling of the charging powers pⱼⁱ of the previously operational chargers Lⱼⁱ.

1-13. (canceled)

14. A method for charging electric energy stores comprising the following steps:
connecting at least two electric energy stores to be charged to in each case one charger,
charging the at least two electric energy stores with in each case one charging power assigned to the respective charger, and
performing closed-loop control with respect to the charging powers, wherein
the instantaneous charging power of each charger is determined, the instantaneous charging powers are added to give an instantaneous total charging power,
the instantaneous total charging power is compared with a predefined upper charging power limit, and
at least one of the charging powers assigned to the respective chargers is reduced when the instantaneous total charging power is greater than the predefined upper charging power limit.

15. The method as claimed in claim 14, wherein the upper charging power limit is between 75% and 99.5% of a maximum charging power.

16. The method as claimed in claim 14, wherein the upper charging power limit is between 80% and 99% of a maximum charging power.

17. The method as claimed in claim 14, wherein the upper charging power limit is between 85% and 95% of a maximum charging power.

18. The method as claimed in claim 14, wherein the upper charging power limit is approximately 90% of a maximum charging power.

19. The method as claimed in claim 14, wherein at least one of the charging powers is reduced stepwise from a rated power, which is provided for charging the respective electric energy store.

20. The method as claimed in claim 14, wherein at least one of the charging powers is increased as soon as the instantaneous total charging power falls below a lower charging power limit, wherein the lower charging power limit is less than the upper charging power limit.

21. The method as claimed in claim 14, wherein the lower charging power limit is between 50% and 95% of the maximum charging power.

22. The method as claimed in claim 14, wherein the lower charging power limit is between 60% and 90% of the maximum charging power.

23. The method as claimed in claim 14, wherein the lower charging power limit is between 70% and 80% of the maximum charging power.

24. The method as claimed in claim 14, wherein the lower charging power limit is approximately 75% of the maximum charging power.

25. The method as claimed in claim 14, wherein the closed-loop control of the charging powers (pⱼⁱ) is dependent on states of charge (Zⱼⁱ) of the respective electric energy stores.

26. The method as claimed in claim 19, wherein when the upper charging power limit is exceeded, first the charging power for at least one of the at least two electric energy stores whose state of charge is higher than the state of charge of the other electric energy stores is reduced.

27. The method as claimed in claim 14, wherein at least one of the upper charging power limit and the lower charging power limit are fixed.

28. The method as claimed in claim 14, wherein at least one of the upper charging power limit and the lower charging power limit are fixed in a manner dependent on the time of day.

29. The method as claimed in claim 14, wherein a time characteristic of the previously determined charging powers is determined.

30. A device for charging electric energy stores, having
at least two chargers for charging in each case one electric energy store with in each case one charging power assigned to the respective charger and
a closed-loop control unit,
wherein the closed-loop control unit is configured to perform closed-loop control with respect to the charging powers of the respective chargers used for charging during charging of at least two electric energy stores, which are each connected to one of the at least two chargers, wherein:
the instantaneous charging power of each of the chargers used for charging the at least two electric energy stores is determined,
the instantaneous charging powers are added to give a total charging power, and
the instantaneous total charging power is compared with a predefined upper charging power limit, and
at least one of the charging powers assigned to the respective chargers is reduced when the instantaneous total charging power is greater than the predefined upper charging power limit.

31. The device as claimed in claim 30, comprising an interface for input-ting operational parameters.

32. The device as claimed in claim 30, comprising at least two charger groups, each having at least two chargers, wherein the closed-loop control of the charging powers takes place independently of one an-other for both charger groups.

33. The device as claimed in claim 30, comprising a modular design.
